(19) United States
(12) Patent Application Publication
(10) Pub. No.: US 2008/0034743 A1
(43) Pub. Date: Feb. 14, 2008

(54) Unidirectional two position throttling exhaust valve

(75) Inventors: Kwin Abram, Columbus, IN (US); Joseph Callahan, Greenwood, IN (US)

Correspondence Address: CARLSON, GASKEY & OLDS, P.C., 400 WEST MAPLE ROAD, SUITE 350, BIRMINGHAM, MI, 48009, US

(73) Assignee: Arvin Technologies, Inc.

(21) Appl. No.: 11/501,157

(22) Filed: Aug. 8, 2006

(51) Int. Cl. F01N 7/00; F02D 9/06

(52) U.S. Cl. 60/324; 123/323

(57) ABSTRACT

An exhaust valve for an exhaust component includes a shaft defining an axis and a flapper valve that is fixed to the shaft for rotational movement about the axis. The flapper valve is mounted within an interior cavity of a valve housing that is defined by an inner diameter. The flapper valve comprises a disc-shaped body that has a maximum flapper diameter that is less than the inner diameter. A unidirectional drive unit is used to move the flapper valve between open and closed positions such that the flapper valve only rotates in one direction about the axis.

### TECHNICAL FIELD

The subject invention relates to a flapper valve that is driven in only one direction about an axis of rotation as the flapper valve moves between open and closed positions.

### BACKGROUND OF THE INVENTION

Exhaust valve assemblies include a flapper valve that is supported on a shaft within an interior cavity of a valve housing. The shaft is supported on bearings for rotation relative to the valve housing. The flapper valve comprises a disc-shaped body that is generally orientated parallel to exhaust flow when in an open position. When the flapper valve rotates from this parallel orientation to a closed position, the flapper valve is at an orientation that is less than a ninety degree rotation from the initial parallel position. This prevents an outer edge of the disc-shaped body from contacting an inner surface of the valve housing. Contact between the flapper valve and valve housing can result in premature wear and undesirable noise.

One disadvantage with this rotational limitation is that the bearings are subjected to non-typical bearing operational conditions. The limited amount of rotation imparts unusual wear characteristics on bearing surfaces, which can lead to premature wear or failure.

An actuator drives the shaft to move the flapper valve between open and closed positions within the valve housing to control exhaust flow. One type of actuator used to drive the flapper valve is a direct current motor. In order to move the flapper valve from the open position, i.e. parallel to exhaust flow, to the closed position, the motor rotates the flapper valve less than ninety degrees in a first direction about an axis of rotation. To return the flapper valve to the open position, the motor rotates the flapper valve in a second, opposite direction about the axis of rotation. Thus, the motor needs to be reversed to move between open and closed positions. This requires a logic circuit to change the polarity of the motor to reverse the direction. This complicates the system and increases cost.

Thus, there is a need for an improved valve actuator with simplified controls and improved bearing life.

### SUMMARY OF THE INVENTION

An exhaust valve assembly utilizes a unidirectional drive unit to drive a flapper valve between open and closed positions by rotating the flapper valve in only one direction about an axis of rotation.

In one example embodiment, the flapper valve is mounted within a valve housing and is supported on a shaft that defines the axis of rotation. The shaft is supported on bearings for rotation relative to the valve housing. The valve housing has an interior cavity that is defined by an inner diameter. The flapper valve comprises a disc-shaped body that is defined by a maximum flapper diameter that is less than the inner diameter. This allows the flapper valve to rotate within the interior cavity without contacting the valve housing.

A unidirectional drive unit is used to rotate the flapper valve within the valve housing between open and closed positions to vary exhaust flow. In one example, the unidirectional drive unit comprises a gear driven direct current motor that is used to drive the flapper valve in only one direction about the axis of rotation. Thus, to move the flapper valve from a closed position to an open position and back to a closed position, the drive unit rotates the flapper valve approximately one hundred and eighty degrees about the axis of rotation.

By rotating the flapper valve in only one direction about the axis of rotation, bearing life is improved and controls for the drive unit are significantly simplified. These and other features of the present invention can be best understood from the following specification and drawings, the following of which is a brief description.

### BRIEF DESCRIPTION OF THE DRAWINGS

FIG. 1 is a schematic view of an exhaust valve assembly incorporating the subject invention.

FIG. 2 is a schematic side view of the exhaust valve assembly of FIG. 1 in an open position.

FIG. 3 is a schematic side view of the exhaust valve assembly of FIG. 1 in a closed position.

FIG. 4 is a schematic side view of the exhaust valve assembly moved from the closed position of FIG. 3 to an open position.

FIG. 5 is a schematic side view of the exhaust valve assembly moved from the open position of FIG. 4 to a closed position.

FIG. 6 is a schematic side view of the exhaust valve assembly moved from the closed position of FIG. 5 to an open position.

### DETAILED DESCRIPTION OF THE PREFERRED EMBODIMENT

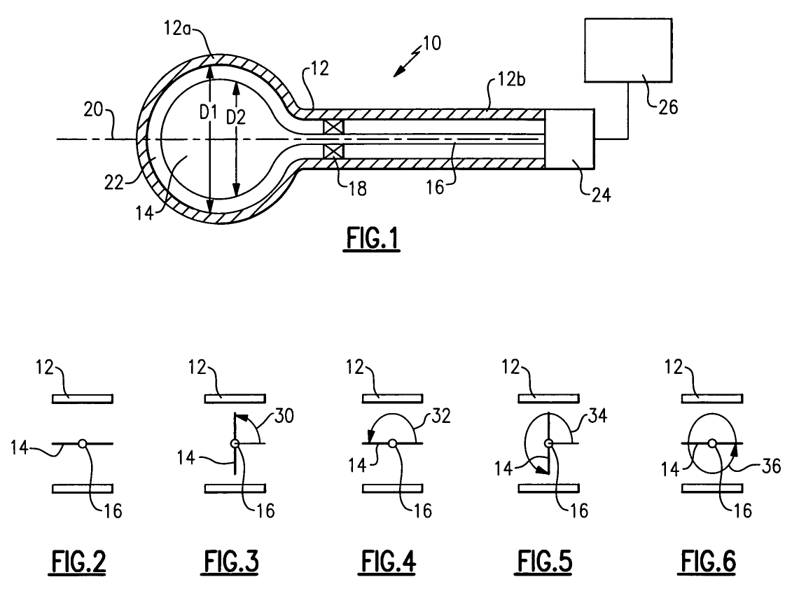

An exhaust valve assembly is shown generally at 10 in FIG. 1. The exhaust valve assembly 10 includes a valve housing 12, a flapper valve 14, and a shaft 16, that is supported by at least one bearing 18 for rotation relative to the valve housing 12. The shaft 16 defines an axis of rotation 20. The flapper valve 14 is fixed to the shaft 16 and rotates with the shaft 16 about the axis of rotation 20.

The valve housing 12 includes a valve portion 12a and a shaft portion 12b. The valve portion 12a includes an inner cavity 22 that receives the flapper valve 14. The inner cavity 22 is defined by an inner diameter D1. The flapper valve 14 comprises a disc-shaped body that is defined by a maximum flapper diameter D2 that is less than the inner diameter D1.

The shaft 16 is coupled to an actuator that comprises a unidirectional drive unit 24. The unidirectional drive unit 24 rotates the shaft 16 and flapper valve 14 in only one direction about the axis of rotation 20 between open and closed positions to vary exhaust flow. A controller 26 generates control signals to the unidirectional drive unit 24 to move the flapper valve 14 between the open and closed positions as needed. In the example shown, the unidirectional drive unit 24 comprises a gear driven direct current (DC) motor.

FIG. 2 shows the flapper valve 14 in an open position where the disc-shaped body is generally orientated in a position that is parallel to exhaust flow through the valve housing 12. In the example shown, this initial open position is defined as a zero degree position, however, the flapper valve 14 could be angled slightly above or below zero degrees in the open position.

To move the flapper valve 14 from this initial open position to a closed position (FIG. 3), the unidirectional drive unit 24 rotates the shaft 16 and the flapper valve 14 in only one direction about the axis of rotation 20. In the example shown, the unidirectional drive unit 24 rotates the flapper valve 14 in a counter-clockwise direction about the axis of rotation 20 as indicated by arrow 30, however, the flapper valve could also be rotated in the opposite direction. In the closed position, the flapper valve 14 has been rotated approximately ninety degrees such that the disc-shaped body is generally perpendicular to the exhaust flow. Because the maximum flapper diameter D2 is less than the inner diameter D1 of the valve housing 12, the flapper valve 14 does not contact the valve housing 12. It should be understood that while a perpendicular orientation, i.e. a ninety degree rotation, is shown in FIG. 3, the flapper valve 14 could be rotated slightly more or less than ninety degrees to move into the closed position.

To move from the closed position in FIG. 3 to a subsequent open position as shown in FIG. 4, the unidirectional drive unit 24 rotates the flapper valve 14 in the same direction about the axis of rotation 20, i.e. a counter-clockwise direction, by approximately ninety degrees. As such, the flapper valve 14 has been rotated a total of one hundred and eighty degrees from the initial open position to a subsequent open position, as indicated by arrow 32.

To move from the subsequent open position in FIG. 4 to a subsequent closed position in FIG. 5, the unidirectional drive unit 24 rotates the flapper valve 14 again in a counter-clockwise direction about the axis of rotation 20 by approximately ninety degrees. As such, the flapper valve 14 has been rotated a total of two hundred and seventy degrees from the initial open position (FIG. 2) to a second closed position as indicated by arrow 34.

Finally, to rotate the flapper valve back to an open position (FIG. 6) from the closed position in FIG. 5, the unidirectional drive unit 24 rotates the flapper valve 14 another approximately ninety degrees about the axis of rotation 20. Thus, the flapper valve 14 has been rotated three hundred and sixty degrees about the axis of rotation 20, as indicated by arrow 36, to move from the open position shown in FIG. 2, through the positions shown in FIGS. 3-5, and back to the open position shown in FIG. 6.

The unidirectional drive unit 24 continues to drive the flapper valve 14 between open and closed positions by rotating the flapper valve in only one direction about the axis of rotation 20. By rotating the flapper valve 14 in only one direction about the axis of rotation 20, bearing life is improved and controls for the actuator are significantly simplified.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An exhaust valve assembly comprising:
a support shaft defining an axis of rotation;
a flapper valve fixed to said support shaft for rotation about said axis of rotation; and
a unidirectional drive unit coupled to said support shaft to move said flapper valve between an open position and a closed position, wherein said unidirectional drive unit rotates said flapper valve in only one direction about said axis of rotation.

2. The exhaust valve assembly according to claim 1 including a valve housing having an inner cavity that receives said flapper valve, said inner cavity defined by an inner diameter, and wherein said flapper valve comprises a disc-shaped body defined by a maximum flapper diameter that is less than said inner diameter such that said flapper valve does not contact said valve housing during rotational movement.

3. The exhaust valve assembly according to claim 1 wherein said flapper valve is orientated in a first position relative to said axis of rotation when in an initial open position and wherein said unidirectional drive unit rotates said flapper valve approximately ninety degrees in a first direction about said axis of rotation to move said flapper valve to said closed position.

4. The exhaust valve assembly according to claim 3 wherein said unidirectional drive unit subsequently rotates said flapper valve approximately ninety degrees in the first direction about said axis of rotation to move said flapper valve from said closed position to a subsequent open position such that said flapper valve has been rotated approximately one hundred and eighty degrees from said initial open position.

5. The exhaust valve assembly according to claim 4 wherein said unidirectional drive unit subsequently rotates said flapper valve approximately ninety degrees in the first direction about said axis of rotation to move said flapper valve from said subsequent open position to a subsequent closed position such that said flapper valve has been rotated approximately two hundred and seventy degrees from said initial open position.

6. An exhaust component assembly comprising:
a valve housing having an interior cavity defined by an inner diameter;
a support shaft extending into said interior cavity and defining an axis of rotation;
a flapper valve fixed to said support shaft for rotation about said axis of rotation wherein said flapper valve comprises a disc-shaped body defined by a maximum flapper diameter that is less than said inner diameter; and
a unidirectional drive unit coupled to said support shaft to rotate said flapper valve in only one direction about said axis of rotation to move said flapper valve between open and closed positions.

7. The exhaust component assembly according to claim 6 wherein said unidirectional drive unit comprises a motor.

8. The exhaust component assembly according to claim 7 wherein said motor comprises a gear driven direct current motor.

9. The exhaust component assembly according to claim 6 wherein said flapper valve rotates three hundred and sixty degrees about said axis of rotation.

10. The exhaust component assembly according to claim 6 wherein said support shaft is supported by at least one bearing for rotation relative to said valve housing.

11. A method for moving an exhaust valve within an exhaust component comprising the step(s) of:
driving a flapper valve within a valve housing in only one direction about an axis of rotation to move between open and closed positions.

12. The method according to claim 11 including using a unidirectional drive motor to rotate the flapper valve.

13. The method according to claim 11 including rotating the flapper valve approximately one hundred and eighty degrees about the axis of rotation to move the flapper valve from an open position to a closed position and back to an open position.

14. The method according to claim 11 including providing the valve housing with an interior cavity defined by an inner diameter, providing the flapper valve as a disc-shaped bodying defined by a maximum flapper diameter that is less than the inner diameter, and mounting the flapper valve within the interior cavity on a support shaft that defines the axis of rotation.
